(19) United States
(12) Patent Application Publication
(10) Pub. No.: US 2026/0127311 A1
(43) Pub. Date: May 7, 2026

(54) LOGOUT MECHANISMS FOR PROVIDING PRIVACY PROTECTION

(71) Applicant: SAP SE, Walldorf (DE)

(72) Inventors: Radoslav Ivanov Sugarev, Petrich (BG); Ivan Krastev Ikonomov, Sofia (BG)

(21) Appl. No.: 18/937,629

(22) Filed: Nov. 5, 2024

(51) Int. Cl. G06F 21/62

(52) U.S. Cl. CPC G06F 21/6245

(57) ABSTRACT

The present disclosure relates to computer-implemented methods, software, and systems for a logout process at a portal web application that embeds one or more other applications. A request to logout a user from a user session at a portal web application is received. The portal web application embeds one or more other web application, where one or more other user sessions exist for the user. Instructions are sent to one or more logout endpoints at the one or more other web applications to trigger one or more logout processes to destroy the one or more other user sessions associated with the user. The user can be logged out by destroying the user session at the portal web application. A notification for a result of the logout for the user can be provided at the portal web application.

### TECHNICAL FIELD

The present disclosure relates to computer-implemented methods, software, and systems for access management and security.

### BACKGROUND

Software applications can provide services and access resources. Resources may be restricted to a limited number of users based on user rights and roles. Tokens, credentials, keys, or other suitable methods and tools can be used to authenticate requests to gain access to restricted resources. Applications can be provided in a shared context where one application can be accessible through another application. When a user requests access to a resource at one application, the user may be validated to determine whether the user is authorized to access the resource, which can happen through an identity provider. If a user requests access through navigating between multiple applications, the user may be validated at each application to perform authentication based on similar or different authentication rules.

### SUMMARY

The present disclosure describes mechanisms to implement a logout process at a portal web application that embedded one or more other applications.

In some implementations, a method includes: receiving a request to logout a user from a user session at a portal web application; determining, at a logout endpoint at the portal web application, whether the portal web application embeds one or more other web applications, wherein one or more other user sessions exist for the user at the one or more other web applications; sending, by the logout endpoint at the portal web application, instructions to one or more logout endpoints at the one or more other web applications to trigger one or more logout processes and to destroy the one or more other user sessions associated with the user at the one or more other web applications; logging out the user by destroying the user session at the portal web application; and providing a notification for a result of the logout for the user at the portal web application.

In some instances, the received request to logout is a first request, and wherein the method further includes: sending a second request to an identity provider to destroy a user session created for the user at the identity provider when the user was logged on the portal web application using the identity provider for an identity authentication.

In some instances, the logging out of the user from the user session at the portal web application is performed before the one or more logout processes triggered at the one or more other web applications are completed.

In some instances, the provided notification for the result is a first notification, and wherein providing the first notification for the result of the logout of the user at the portal web application includes: receiving one or more notifications from one or more logout executions for the user at the one or more other user sessions, the one or more logout executions being performed at an identity provider associated with the one or more other web applications. In some instances, the identity provider associated with the one or more other web applications can be identical to an identity provider used for authenticating the user for the user session at the portal web application.

In some instances, providing the notification for the result of the logout includes providing one or more statuses of execution of the one or more logout processes as triggered by the one or more logout endpoints at the one or more other web applications.

In some instances, determining whether the portal web application embeds the one or more other web applications includes obtaining input from an identity provider for at least one more user session associated with the user that is existing at the identity provider for the user and is associated with at least one web application embedded in the portal web application, wherein authentication at the at least one web application embedded in the portal web application is performed at the identity provider.

In some instances, determining whether the portal web application embeds the one or more other web applications includes: obtaining a notification from an identity provider, the notification being indicative of another user session for the user at another web application embedded in the portal web application. In some instances, determining whether the portal web application embeds the one or more other web applications includes: determining, by the logout endpoint at the portal web application, whether an additional embedded web application to the portal web application is registered with another identity provider for executing user authentication. Sending instructions can include sending further instructions to another identity provider for triggering a logout process to destroy a user session associated with the user at the additional embedded web application.

In some instances, the method further includes: receiving a new request to log-in at the portal web application by another user; in response to receiving the request, determining whether another user is associated with an existing user session; in response to determining that another user is not associated with an existing user session, triggering an authentication of another user at an identity provider; and in response to determining that another user is associated with an existing user session, providing access to another user to resources at a first other web application embedded in the portal web application upon authentication for the first other web application without performing a new authentication for another user at the portal web application.

The described subject matter can be implemented using a computer-implemented method; a non-transitory, computer-readable medium storing computer-readable instructions to perform the computer-implemented method; and a computer-implemented system including one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example architecture 100 in accordance with implementations of the present disclosure.

FIG. 2 is a flowchart illustrating an example of a computer-implemented method for managing logout requests at a portal web application embedding other web applications, according to an implementation of the present disclosure.

FIG. 3A and 3B are sequence diagrams illustrating an example of a computer-implemented method for performing authentication, according to an implementation of the present disclosure.

FIG. 4A and 4B is a sequence diagram illustrating an example of a computer-implemented method for performing a logout process, according to an implementation of the present disclosure.

FIG. 5 is an activity diagram illustrating an example of a computer-implemented method for invoking application functionality implemented at logout endpoints of applications in the context of executing a logout process, according to an implementation of the present disclosure.

FIG. 6 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes mechanisms to implement a logout process at a portal web application that embeds one or more other applications and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Verifying an identity of an entity (e.g., a user, an application, or a service) to access a system, network, or application is known as authentication. It is performed by confirming that the credentials (e.g., user password, a security token, biometrics, digital certificate, or other data) provided by the entity are accurate. For example, when a user logs into an application or website, session authentication (e.g., token-based authentication) can generate an identifier for the user session which can be used to verify further user requests. A new session ID can be generated and can be linked to an account of the user for each log-in to an application or website. The user’s browser application can then receive the session identifier as a cookie that can be saved on the user’s device. For each subsequent request of the user, the user’s browser can use the session identifier to confirm the user’s identity and to grant access to secured resources.

Websites and web applications can employ cookie-based authentication as a user authentication technique. For example, after an entity (e.g., a user or an application) logs in to a website with a browser, cookies can be used/stored in the browser and kept on a computing device. In some implementations, a cookie with a special identifier linked to an entity account can be created by the website when the entity logs in. The website may recognize and authenticate the entity without requesting a subsequent authentication by using the cookie at the website on subsequent visits. However, security configurations can be applied to websites and web applications that may restrict cookie authentication. In some instances, sharing of the cookies between browser tabs in different contexts may be limited, and this may reflect the authentication mechanisms. For example, in the current state of implementing browser user privacy, existing mechanisms for executing logout processes for end users, when a first application (e.g., a website) is embedded within another, second application (e.g., another website, for example, accessible through a hyperlink or other access navigation) but the first application has a differing domain top-level site from the second application, may be inefficient due to restrictions of usage of cookies issued in different domains (or contexts).

In accordance with the present implementation, a logout process can be implemented with consideration for improving the security of users that access applications that include multiple sub-applications in different domains or contexts, which may leave some sessions for the user open even when the user had logged out of the main application. When applications run in a shared environment as they are embedded in one another, accessing those applications through a common or shared device by multiple users can be associated with risks of unauthorized use of sessions of one user by another user due to the fact that some sessions may be maintained for embedded application even then a user had logged out of the top-level application in the hierarchy of the embedded applications. If an application that supports logout execution that relies on cookies, and has no central session management may be associated with higher security risks of inadvertently providing access to resources to unauthorized users due to vulnerabilities of allowing users to enter other users’ sessions due to inappropriate logout process executions. The present application provides tools and techniques for managing a logout process in the context of embedded applications that supports improved security compared to conventional solutions, where the mechanisms for implementing the logout process are configured to efficiently identify the session that needs to be terminated for the logout process to be successfully executed.

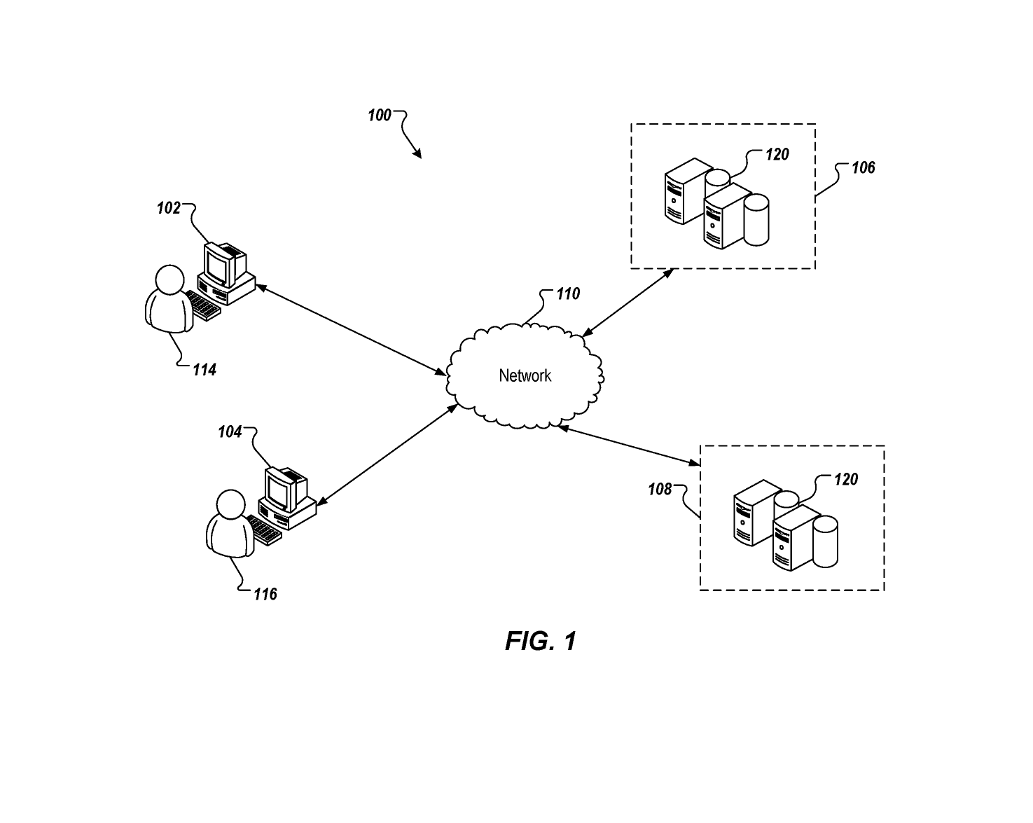

FIG. 1 depicts an example architecture 100 in accordance with implementations of the present disclosure. In the depicted example, the example architecture 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications, application servers, and authorization servers to support the execution of secure requests between the client applications and the application server. In some instances, the users 114 or 116 may access a client application through the network 110. The client application may be communicatively coupled with an application server. The application server may include application logic implemented to provide services and resources to end users.

In some instances, the environments 106 and 108 may host a portal web application that can embed multiple other web applications. For example, the portal web application can be considered as a portal website that provides tools and techniques to access resources provided by other web applications that are accessible through the portal website. In some instances, the portal web application can be configured to interact with users, where a user can be provided with access to the portal web application upon authentication. The portal web application can be associated with a particular identity provided that handles authentication requests. In some instances, the authentication provider can be configured to run at the environments 106 or 108, or in some cases can be configured to run in another environment, such as a cloud environment, and be accessible to multiple applications at systems view the network 110 or other network.

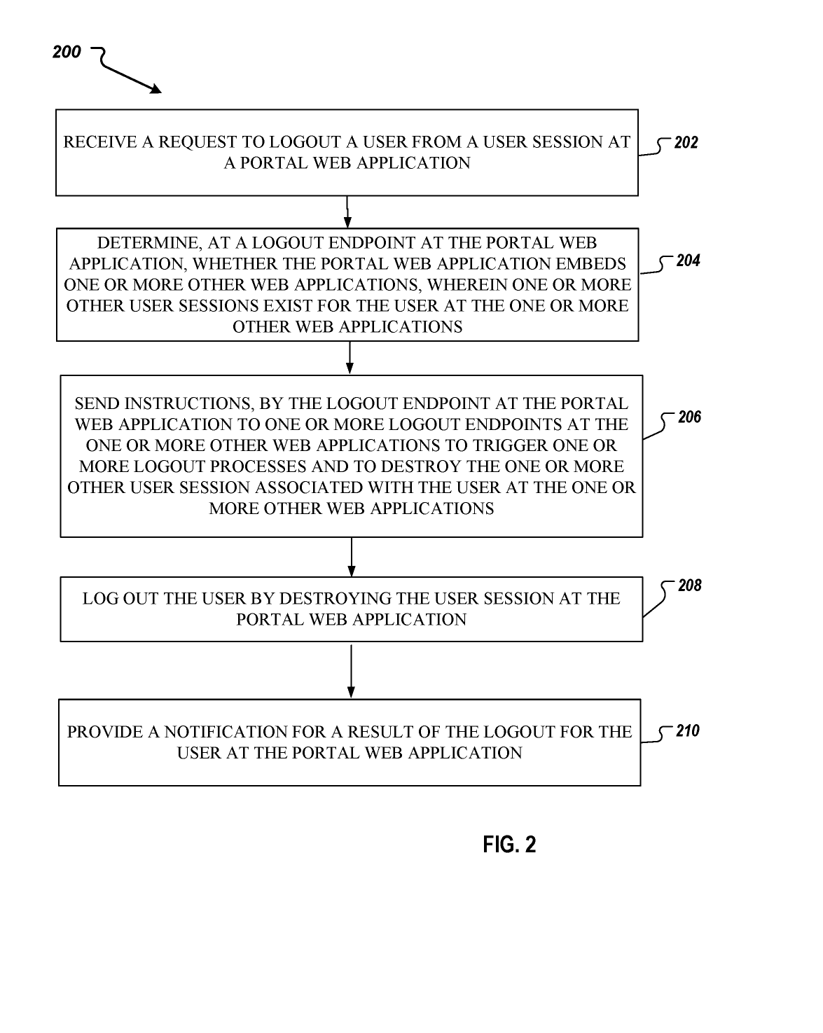

FIG. 2 is a flowchart illustrating an example of a computer-implemented method 200 for managing logout requests at a portal web application embedding other web applications, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, a request to logout from a user session at a portal web application is received. For example, the request can be received at a logout endpoint configured at the portal web application, where the logout endpoint is implemented with logic to process requests for login and logout based on configured embedded web application for the portal web application and relevant identity providers (one or more available providers for web applications that can be used by users or groups of users). When the request to logout is received at the portal web application, another request for logging out the user at the identity provider used for authenticating the user at the portal web application can be sent. The send request can include a request to destroy a user session created for the user at the identity provider when the user was logged on to the portal web application using the identity provider for an identity authentication. From 202, method 200 proceeds to 204.

At 204, a determination is made, at a logout endpoint at the portal web application, whether the portal web application embeds one or more other web applications. One or more other user sessions exist for the user at the one or more other web applications. In some instances, to determine whether the portal web application embeds one or more other web applications, input from the identity provider can be obtained. The input can be associated with information for other user sessions opened at the identity provider for the user and is associated with at least one of the web applications embedded in the portal web application. In some instances, the identity provider can trigger a logout process for the other sessions by providing information for the sessions to the web browser where the portal web application is running. The web browser can trigger the logout by sending a request to a logout endpoint at the portal application, which will trigger requests to logout endpoints of embedded web applications. In some instances, the triggered logout can be for all embedded web application in the portal web application, or to a subset of the embedded web applications. In some instances, the set of embedded applications for which a logout process can be determined based on locally configured logic at the portal web application, or can be dynamically obtained (e.g., from a user or external entity, from an external storage, etc.) upon triggering the logout process as determined by the identity provider. From 204, method 200 proceeds to 206.

At 206, instructions are sent by the logout endpoint at the portal web application to one or more logout endpoints at the one or more other web applications to trigger one or more logout processes and to destroy the one or more other user sessions associated with the user at the one or more other web applications. From 206, method 200 proceeds to 208.

At 208, the user is logged out by destroying the user session at the portal web application. In some instances, destroying the user session can include deleting stored session data for the user (e.g., including the generated session identifier and other state information about user’s interaction with the application) for the portal web application. From 208, method 200 proceeds to 210. In some instances, the logging out of the user from the user session at the portal web application can be performed before the one or more logout processes triggered at the one or more other web applications are completed. From 206, method 200 proceeds to 208.

At 210, a notification for a result of the logout for the user is provided at the portal web application. In some instances, the notification is provided based on receiving input from the one or more other web applications embedded in the portal web application for the successful execution of the logout process. In some instances, wherein providing the notification for the result of the logout includes providing one or more statuses of execution of the one or more logout processes as triggered by the one or more logout endpoints at the one or more other web applications.

In some instances, the embedded web application can use different identity providers for identity authentication from the one used by the portal web application. In that case, when logout is requested at the portal web application, the identity provider can determine other user sessions for other embedded web application that use the same identity provider. For other embedded web applications that use another identity provider, their respective identity provider can be queried to perform the logout. Upon triggering the logout process for an embedded web application, the respective user session at the identity provider can be destroyed as well as the session (and cookies if those are maintained) at the embedded web application.

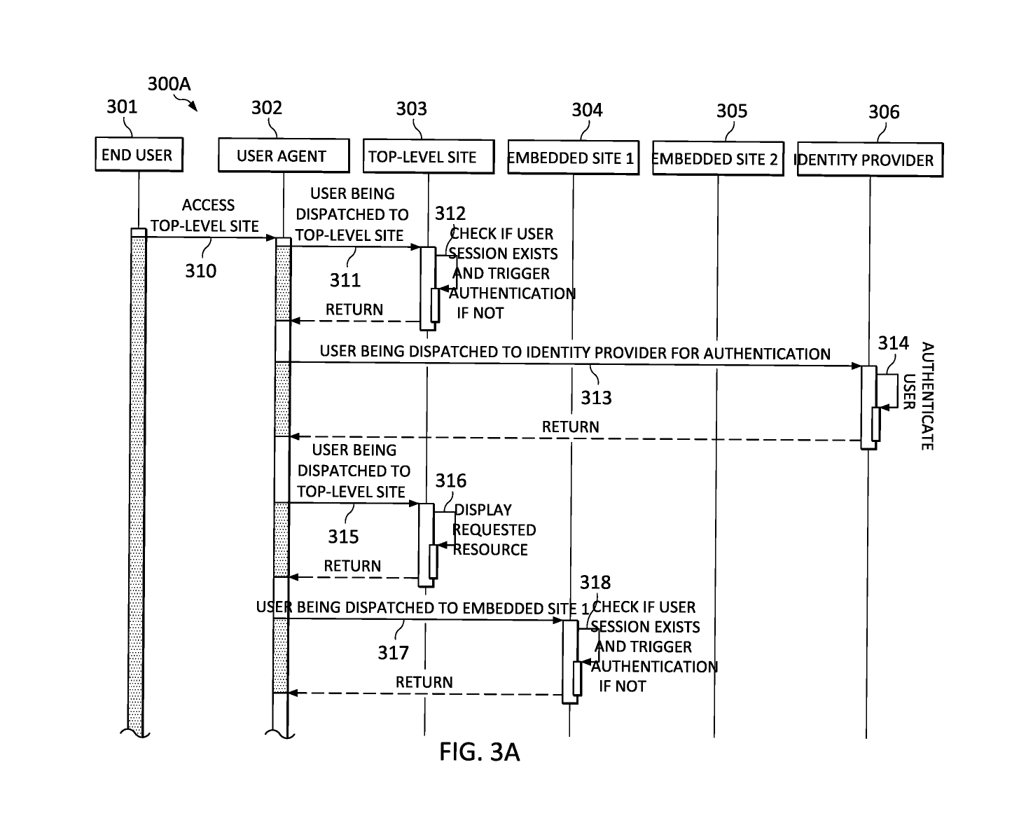

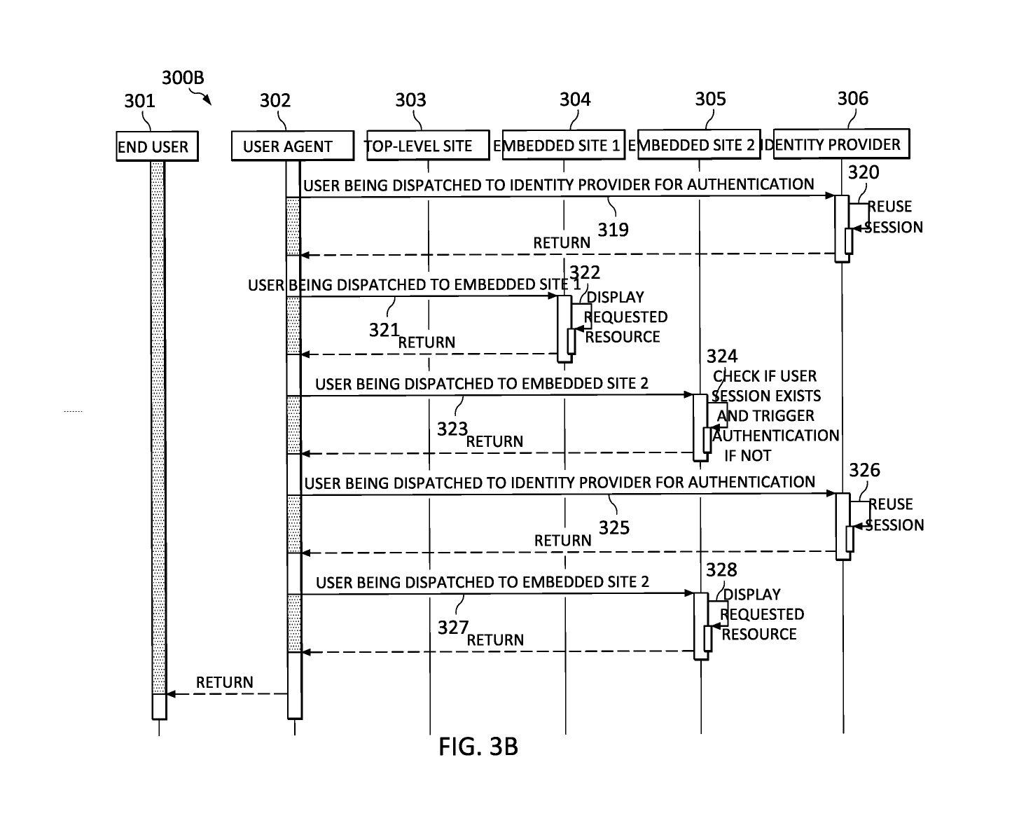

In some instances, a new request to log-in from the portal web application can be received. That new request can be received from another user. In response to receiving the request, it can be determined whether the other user is associated with an existing user session at the portal web application. If it is determined that the other user is not associated with an existing user session, it can be determined that the other user had not been logged in at the portal web application, and an authentication process for the other user at the identity provider can be triggered. For example, the authentication process can be substantially the same as the example process 300 described in relation to FIGS. 3A and 3B.

In some instances, if it is determined that the user is associated with an existing user session, it can be determined that the user is logged in at the portal web application. The other user can be provided with access to resources at a first other web application that is embedded in the portal web application. The access to the resources at the first other web application can be provided upon successfully authenticating the other user at the first other web application without performing a new authentication for that other user at the portal web application. In some instances, if the first other web application is associated with the same identity provider as the portal web application, during the authentication, the user session for the other user at the identity provider for the portal web application can be reused for the authentication at the first other web application, e.g., as described in relation to FIG. 3A.

FIGS. 3A and 3B are sequence diagrams illustrating an example of a computer-implemented method 300 (shown as 300A at FIG. 3A and 300B at FIG. 3B) for performing authentication, according to an implementation of the present disclosure. In some instances, the method 300 can be executed when an end user 301 is requesting (at 306) to access a web application (e.g., top-level site 303) that embeds one or more other web applications (e.g., embedded site 304 and embedded site 305). In some instances, the performed authentication is described in relation to FIGS. 3A and 3B are associated with a request from the end user 301 to log on to a web application, where the web application can be such as the portal web application as described in relation to FIG. 2.

For example, the top-level site 303 embeds two other web applications, embedded site 304 and embedded site 305, so that when the top-level site 303 is accessed, the user interface of the top-level site includes user interface operators (e.g., links, buttons, interactable tools, etc.) that can trigger accessing at least one of the embedded web applications from the browser where the top-level site 303 is loaded. In some instances, an embedded web application (e.g., embedded site 304 or 305) can have a different domain top-level site compared to the top-level site 303. The embedded web application can be loaded in another web browser tab (or page) when requested to be loaded from the top-level site 303.

A user agent 302 such as a browser application can receive the request (at 310) of the end user 301 to access the top-level site 303 is accessed by a user, and the user agent 302 can direct the end user 301 to a user interface of the top-level site 303 that is rendered at the user agent 302. When the top-level site 303 is requested to be loaded, at 312, it can be determined whether a user session for the end user 301 exists. If there is no session existing for the end user 301 at the top-level site 303, an authentication process can be triggered, for example, at the identify provider 306.

Based on the received request from the end user 301, the top-level site 303 can initiate authentication and can redirect, at 313, the user to the identity provider 306 to verify the identity of the end user 301. After successful authentication at 314, the identity provider 306 can redirect the end user 301 back to the top-level site 303. The user agent 302 can receive a response from the identity provider 306 for the successful authentication of the end user 301. At 315, the user agent 302 can redirect the end user 301 to the top-level site 303. The top-level site 303 can display the content of the application or perform other actions, e.g., provide requested resources by the end user 301 with the initial request 310. The top-level site 303 can initiate the loading of the embedded site 304 and 305 as part of the loaded logic of the top-level site 303 based on the request. The user agent 302 can provided with the identification of the embedded sites that are included in the top-level site 303, and can initiate requests, such as the request 317, to load the embedded site 304.

Upon receipt on the request 317, the embedded site 304 can check, at 318, whether there is a user session that was pre-existing for the end user 301. If such a session was not pre-existing, the identity provider 306 can perform authentication, and if a session was already existing, then the session can be reused. In some instances, the same authentication process can be initiated for the embedded sites 304 and 305 as for the top-level site 303. In some instances, the same identity provider (e.g., identity provider 306) or different identity providers can be used for authenticating the end user 301 at the embedded sites 304 and 305 and at the top-level site. In some instances, the embedded site 304 can be associated with an identity provider that is different from the identity provider associated with the embedded site 305, where in some cases, both these providers can be different from the identity provider associated with the top-level site.

At 319, the user agent 302 can send a request for authentication to the identity provider 306 to perform authentication. The identity provider 306 determines, at 320, that there is an existing session for the end user 301, i.e., the session that was started when the end user was authenticated for the top-level site since the top-level site and the embedded site 304 use the same identity provider 306.

At 321, the user agent 302 can request to display a user interface of the embedded site 304, at 321, and the embedded site 304 can display, at 322, the user interface of the embedded site 304. In some instances, the request 321 to display the user interface of the embedded site 304 can include a request for resources, such as user interface content and/or tools. When the embedded site 304 receives the request 321, the embedded site 304 can display the requested resources at 322.

After requesting resources from the first embedded site 304, the user agent 302 requests resources from the second embedded site 305, where similar operations for authenticating the end user 301 can be performed, for example, at the identity provider 306 (or at another one, not shown on FIGS. 3A and 3B).

At FIG. 3B, the user agent 302 requests, at 323, resources from the embedded site 305, and the embedded site 305, at 324, checks whether there is an existing user session for the user associated with the request. If there is no user session at the embedded site 305 for the end user 301, the user agent 302 sends, at 325, a request to perform identity authentication for the end user 301 at the identity provider 306. The identity provider 306 is the provider configured for the authentication for the embedded site 305, however, other identity providers may be as well configured (not shown on FIG. 3B).

At 326, the identity provider can reuse the existing session for the end user 301 at the identity provider and upon receipt of a notification for the reuse, the user agent 302 can request, at 327, from the embedded site 305 to provide requested resources. The embedded site 305 can display, at 328, the requested resources at a user interface of the embedded site 305. The embedded site 305 can be displayed to the end user 301 at the user agent 302.

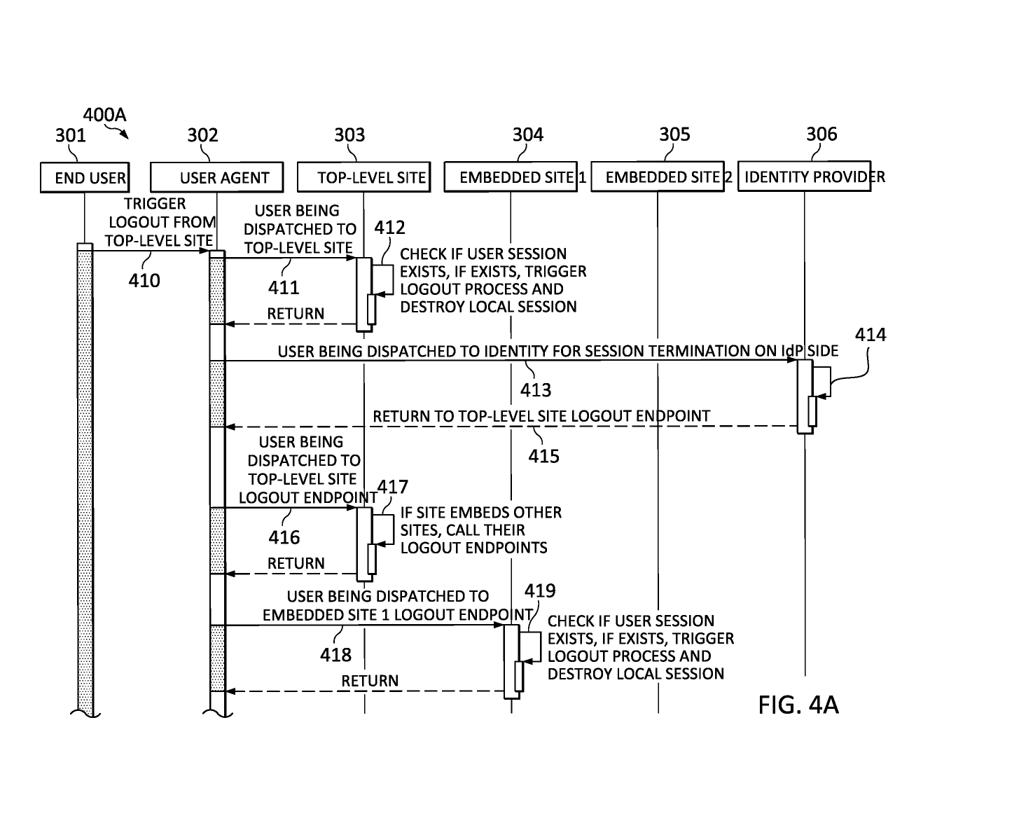

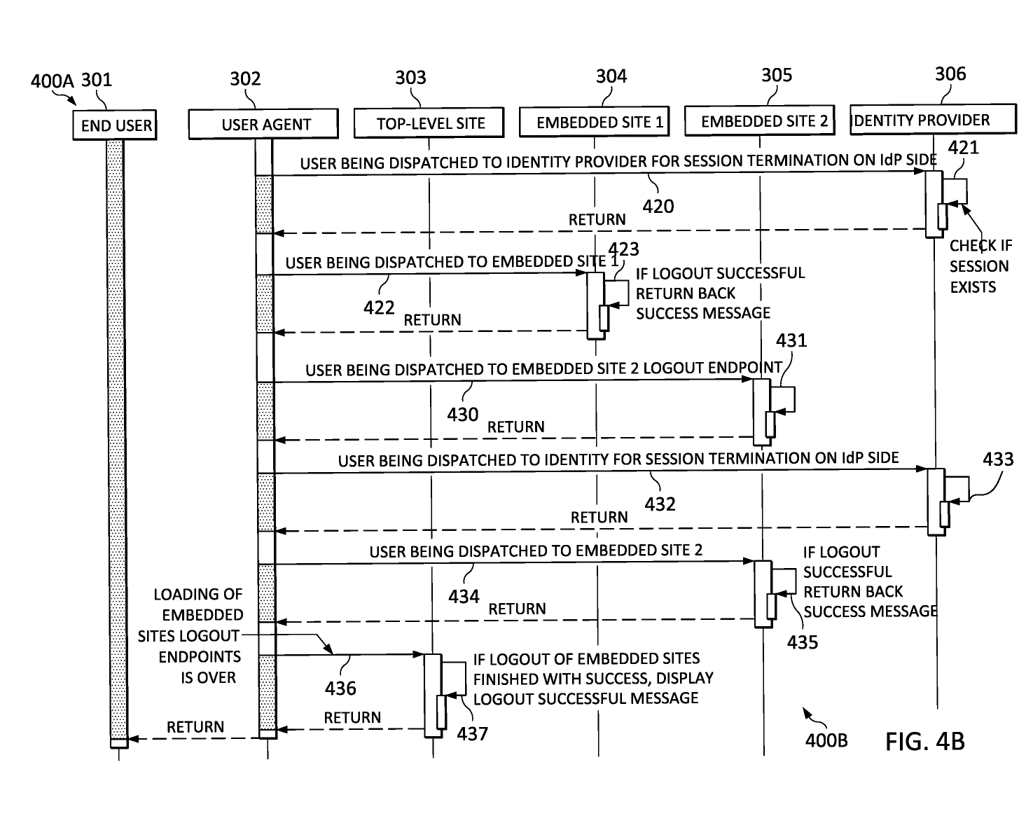

FIG. 4A and 4B is a sequence diagram illustrating an example of a computer-implemented method 400 (shown as a 400A at FIG. 4A and 400B at FIG. 4B) for performing a logout process, according to an implementation of the present disclosure. In accordance with the present implementations, the computer-implemented method 400 can enable the proper logout of applications embedded in a third-party context by defining an extension endpoint to a top-level site (e.g., a portal web application as described in relation to FIG. 2). The top-level site can be a root top application within a hierarchy of applications embedded into the top application (e.g., a top-level site).

The method 400 can be executed for a user who had been logged in to a top-level site, for example, the top-level site 303 of FIGS. 3A and 3B, where the top-level site 303 includes two embedded sites – 304 and 305. In some instances, the top-level site may include just one or more than two embedded sites and some or all of the embedded sites may use the same (identical) identity provider or another identity provider when the user is authenticated at the respective embedded site.

At 410, the end user 301 can request to the user agent 302 to be logged out of the top-level site 303. When the request is received, the user agent 302 can forward the request for logging out to the top-level site 303 so that the logout is performed for the top-level site and also for any embedded sites into which the end user 301 is logged on. The end user 301 requests to log out from the top-level site, and such logout is configured to be performed not only on top-level site level, but also for the embedded sites so that there are no user sessions left for the embedded site that were triggered through the top-level site log-in process (as in FIG. 3A).

At 411, the user agent 302 can send a request for the logout to the top-level site 303, and at 412, the top-level site 303 can check if there is a user session that exists for the end user 301. If it exists (e.g., when the end user 301 had been logged on at the top-level site according to the method 300 of FIGS. 3A and 3B), the top-level site 303 can trigger a logout process to destroy (delete) the local user session at the top-level site 303. In some instances, the local user session at the top-level site 303 can be destroyed after logging out from the embedded sites as described at 423.

At 413, the user agent 302 provides information about the end user 301 and the request for logout to the identity provider 306. Based on the information about the end user 301 that is being logged out, at 414, the identity provider 306 can trigger to destroy any session-related data for the end user 301 in relation to the top-level site 303, as well as trigger logout process(es) for any other application into which the end user 301 is logged on through the identity provider 306 (not shown on FIG. 4A). Once the logout process is over, the identity provider 306 will be able to redirect the end user 301 back to the top-level site 303 from where the logout process has been triggered.

Generally, the identity provider 306 can shared among the top-level site 303 and the embedded sites 304 and 305. In those cases, the identity provider can try to destroy the sessions for all the sites. However, if the embedded sites use cookies as a mechanism for node affinity or as a session identifier, then the request made by the identity provider may not result in destroying the session. If different identity providers are used for the different sites, then the destroying of the sessions cannot happen from a single identity provider, and the destroying of the sessions can be handled individually.

In accordance with implementations of the present disclosure, the top-level site 303 is configured with a mechanism through which upon successful logout of the end user 301 from the top-level site 303, the session of the embedded site(s) can be destroyed as well. In some instances, even if the logout from the embedded sites can be triggered in response to a confirmation of a successful logout on the identity provider site for the top-level site, the logout for the embe3dded sites can be triggered independently and/or at other time (e.g., as configured in the implementation), which can be before or after the logout from the top-level site. So, regardless of the way and the time at which the logout for the embedded sites is triggered, the top-level site 303 can the logout endpoints of all embedded sites that it is configured, for example, through invoking an iFrame. In some instances, when a logout process is triggered, it is not required that logout endpoints of all embedded sites are loaded, and in some instances, one set of the endpoints can be loaded, e.g., as per a selection (provided by a user or dynamically chosen) or configuration parameter.

When the identity provider 306 triggers the logout process for the embedded sites, the identity provider 306 returns, at 415, the logout endpoints for the embedded sites of the top-level site 303 that the end user 301 is logged onto. At 416, the user agent 302 begins to dispatch a request for logout to the to-level site logout endpoint. The top-level site 303 can determine the embedded sites and their logout endpoints (e.g., based on those being preconfigured for the top-level site 303 or dynamically provided to the top-level site upon request or event). At 417, the top-level site 303 sends requests to the logout endpoints of the embedded sites, where the requests are sent to the embedded site 303 and 304 through the user agent 302. At 418, the user agent dispatches a request for logout to the embedded site 304. FIG. 4B shows a request (at 430) from the user agent to logout from the embedded site 305.

At 419, the embedded site 304 determines if there is an existing session for the end user 301, and when it is determined that it exists, a logout process is triggered. In some instances, the local user session at the embedded site can be destroyed. At 420, a request is sent by the user agent 302 to the identity provider 306 to request the logout of the end user 301. At 421, the identity provider determines that a user session exists and destroys the session of the end user for the embedded site 304 at the identity provider 306. A notification for the successful logout for the embedded site 304 at the identity provider 306 can be provided to the user agent 302. At 424, the end user 301 can be redirected to the embedded site 304, where a message for a successful logout can be displayed at 423.

FIG. 4B is a continuation of the process at FIG. 4A, where the user agent 302 continues with the logout process triggering for the other embedded site 305 at the top-level site 303. At 430, the user agent 302 sends a request to a logout endpoint at the embedded site 305. At 431, the embedded site 305 can check if there is a user session that exists for the end user 301 and if the session exists, to trigger, in a similar manner as for the embedded site 304, a logout process for the embedded site 305. A local session for the end user 301 can be destroyed at the embedded site 305, and the user agent 302 can provide a request to the identity provider 306, at 432, to destroy the user session for the embedded site 305 at the identity provider 306 for the end user 301. At 433, the identity provider 306 can determine if a session exists, and if it exists, the user session at the identity provider for the embedded site 305 can be destroyed, and a message with a notification for the successful logout can be triggered to be provided to the end user 301 at the user agent 302. The user agent 302 dispatches the information for the successful destruction of the user session at the identity provider 306 (at 434), and the embedded site 305 determines that the logout had been successfully executed, at 435.

At 436, the user device can provide information for the logout for the embedded sites to the top-level site 303, and at 437, the top-level site can successfully determine that the logout has finished and provide a notification to the user agent. It can be appreciated that the order of logging out from the top-level site first and then from the embedded sites can be different from the example order shown on FIGS. 4A and 4B. For example, the top-level site 303 can execute the logout for the end user 301 after the logout for the embedded sites has been completed.

For example, once the logout endpoints of the embedded sites have responded with a success message(s), the top-level site 303 can display to the end user 301 a page indicating that the logout process is over with success.

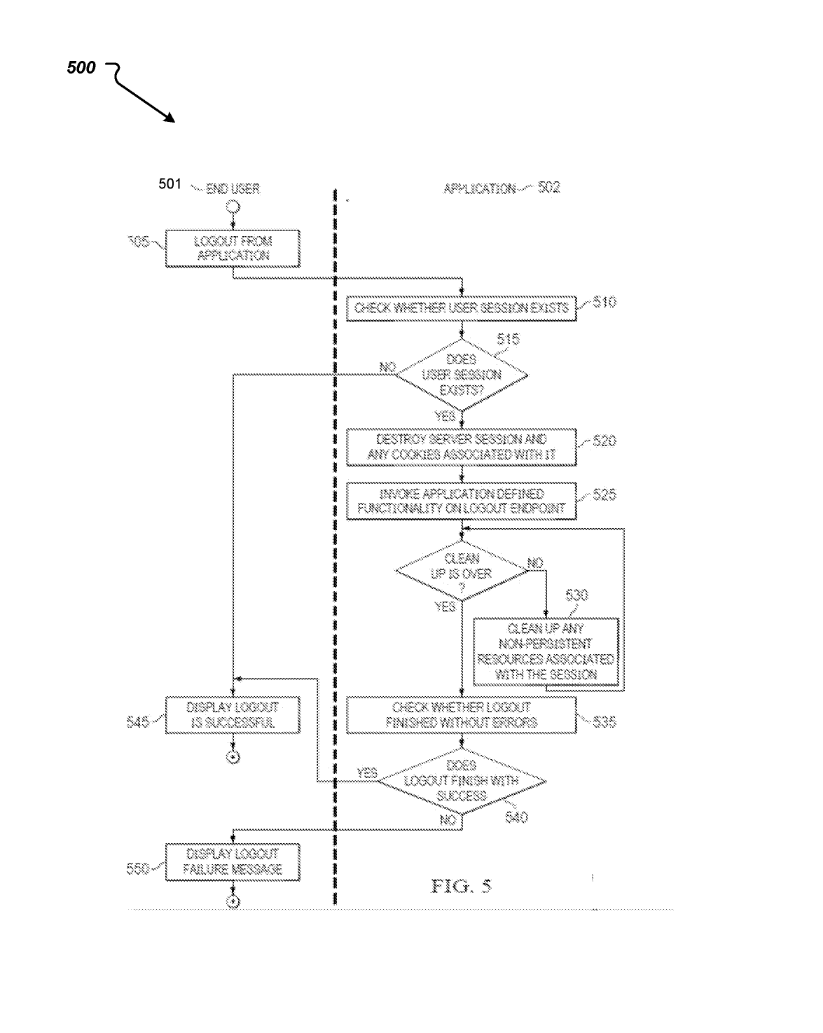

FIG. 5 is an activity diagram illustrating an example of a computer-implemented method 500 for invoking application functionality implemented at logout endpoints of an application in the context of executing a logout process, according to an implementation of the present disclosure. The application can be substantially similar to the top-level site 303 of FIGS. 3A, 3B, 4A, and 4B.

An end user 501 can request, at 505, to logout from the application 502. For example, the end user 501 could have been logged into the application 502 based on authenticating at an identity provider, such as the identity provider 306 of FIGS. 3A, 3B, 3C, and 3D. When the logout request is received by the application 502, a check (at 510) can be triggered at the application 502 to determine whether user sessions exist for the end user 501.

If it is determined, at 515, that there are user sessions for the end user 501, at 520, the sessions at the application can be destroyed and any cookies associated with the session can be deleted. If it is determined, at 515, that there are no user sessions for the end user 510, a notification can be provided, at 545, to the end user 501 that the logout is successfully executed (or completed).

In response to destroying the user session at the application 502 at 525, application-defined functionality can be invoked. The application-defined functionality can be functionality implemented at the application 502 and triggered at the logout endpoint of the application 502. The application-defined functionality can be implemented to determine if there is data or resources associated with the user session that are to be deleted, in relation to a destroyed user session. A check for clean-up of such data and resources can be performed, and if it is determined that there are further resources associated with the end user 501, such as cookies or other metadata, the resources can be deleted as part of a clean-up process at 520. The resources that are deleted can be identified as non-persistent resources associated with the user session that is destroyed and occupying storage, while the data would not be needed after the session is destroyed.

If based on invoking the application-defined functionality, it is determined that there is no more data that needs to be deleted (e.g., as part of the clean-up process at 530), at 535, a check can be performed to determine whether the logout of the end user 501 at the application 502 had finished successfully (i.e., without errors for the logout execution for the application 502 and/or for embedded applications in the application 502). At 540, it can be determined if the logout was successful, and if it was, a display notification indicative of the successful logout can be provided for display to the end user 501 (at 545). If the logout process was not successful (as determined at 540), a failure message for the unsuccessful logout can be displayed at 550 for the end user 501. In some instances, a new logout process can be triggered if the logout was not successful as notified to the user at 550.

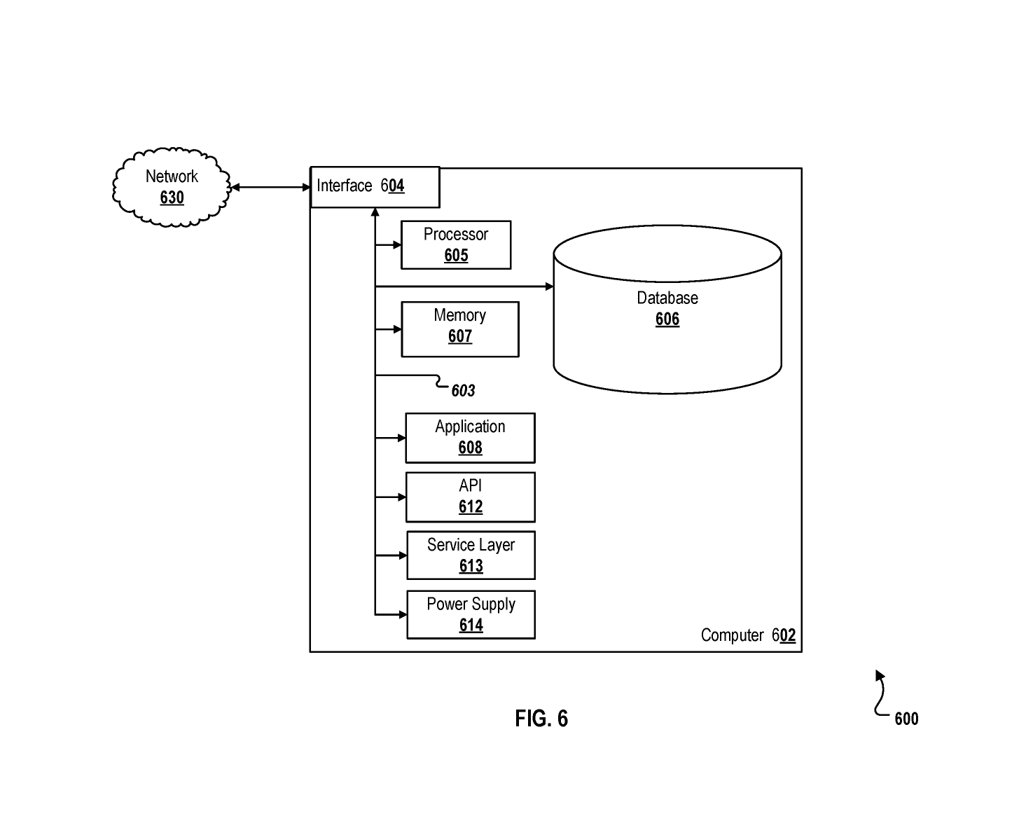

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, computer-implemented system 600 includes a Computer 602 and a Network 630.

The illustrated Computer 602 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 602 can include an input device, such as a keypad, keyboard, or touch screen, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as, for example, a client, network component, a server, a database, another persistency, or a combination of roles for performing the subject matter described in the present disclosure. The illustrated Computer 602 is communicably coupled with a Network 630. In some implementations, one or more components of the Computer 602 can be configured to operate within an environment, or a combination of environments, including cloud-computing, local, or global.

At a high level, the Computer 602 is an electronic computing device operable to receive, transmit, process, store, or manage data and information associated with the described subject matter. According to some implementations, the Computer 602 can also include or be communicably coupled with a server, such as an application server, e-mail server, web server, caching server, streaming data server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory or conventional database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602. The Database 606 can hold and operate on at least any data type mentioned or any data type consistent with this disclosure.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user- or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the terms “client,” “user,” or other appropriate terminology can be used interchangeably, as appropriate, without departing from the scope of the present disclosure. Moreover, the present disclosure contemplates that many users can use one Computer 602, or that one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The terms “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual’s action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and the time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example, LINUX, UNIX, WINDOWS, MAC OS, ANDROID, or IOS, or a combination of operating systems.

A computer program, which can also be referred to or described as a program, software, a software application, a unit, a module, a software module, a script, code, or another component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from, or transfer data to, or both, one or more mass storage devices for storing data, for example, magnetic, magneto-optical disks, or optical disks. However, a computer does not need to have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media, and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user’s mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, or in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1: A computer-implemented method, comprising:

receiving a request to logout a user from a user session at a portal web application;

determining, at a logout endpoint at the portal web application, whether the portal web application embeds one or more other web applications, wherein one or more other user sessions exist for the user at the one or more other web applications;

sending, by the logout endpoint at the portal web application, instructions to one or more logout endpoints at the one or more other web applications to trigger one or more logout processes and to destroy the one or more other user sessions associated with the user at the one or more other web applications;

logging out the user by destroying the user session at the portal web application; and

providing a notification for a result of the logout for the user at the portal web application.

Example 2: The computer-implemented method of Example 1, wherein the received request to logout is a first request, and wherein the method further comprises:

sending a second request to an identity provider to destroy a user session created for the user at the identity provider when the user was logged on the portal web application using the identity provider for an identity authentication.

Example 3: The computer-implemented method of Example 1 or 2, wherein the logging out of the user from the user session at the portal web application is performed before the one or more logout processes triggered at the one or more other web applications are completed.

Example 4: The computer-implemented method of any one of the preceding Examples, wherein the provided notification for the result is a first notification, and wherein providing the first notification for the result of the logout of the user at the portal web application comprises:

receiving one or more notifications from one or more logout executions for the user at the one or more other user sessions, the one or more logout executions being performed at an identity provider associated with the one or more other web applications.

Example 5: The computer-implemented method of Example 4, wherein the identity provider associated with the one or more other web applications is identical to an identity provider used for authenticating the user for the user session at the portal web application.

Example 6: The computer-implemented method of any one of the preceding Examples, wherein providing the notification for the result of the logout comprises providing one or more statuses of execution of the one or more logout processes as triggered by the one or more logout endpoints at the one or more other web applications.

Example 7: The computer-implemented method of any one of the preceding Examples, wherein determining whether the portal web application embeds the one or more other web applications comprises:

obtaining input from an identity provider for at least one more user session associated with the user that is existing at the identity provider for the user and is associated with at least one web application embedded in the portal web application, wherein authentication at the at least one web application embedded in the portal web application is performed at the identity provider.

Example 8: The computer-implemented method of any one of the preceding Examples, wherein determining whether the portal web application embeds the one or more other web applications comprises:

obtaining a notification from an identity provider, the notification being indicative of another user session for the user at another web application embedded in the portal web application.

Example 9: The computer-implemented method of Example 7, wherein determining whether the portal web application embeds the one or more other web applications comprises:

determining, by the logout endpoint at the portal web application, whether an additional embedded web application to the portal web application is registered with another identity provider for executing user authentication,

wherein sending, by the logout endpoint at the portal web application, instructions, comprises:

sending further instructions to another identity provider for triggering a logout process to destroy a user session associated with the user at the additional embedded web application.

Example 10: The computer-implemented method of any one of the preceding Examples, comprising:

receiving a new request to log-in at the portal web application by another user;

in response to receiving the request, determining whether another user is associated with an existing user session;

in response to determining that another user is not associated with an existing user session, triggering an authentication of another user at an identity provider; and

in response to determining that another user is associated with an existing user session, providing access to another user to resources at a first other web application embedded in the portal web application upon authentication for the first other web application without performing a new authentication for another user at the portal web application.

Example 11: A non-transitory, computer-readable medium storing one or more instructions executable by a computer system to perform one or more operations according to any one of the methods of Examples 1 to 10.

Example 12: A computer-implemented system, comprising:

one or more computers; and

one or more computer memory devices interoperably coupled with the one or more computers and having tangible, non-transitory, machine-readable media storing one or more instructions that, when executed by the one or more computers, perform one or more operations according to any one of the methods of Examples 1 to 10.

What is claimed is:

1. A computer-implemented method, comprising:
receiving a request to logout a user from a user session at a portal web application;
determining, at a logout endpoint at the portal web application, whether the portal web application embeds one or more other web applications, wherein one or more other user sessions exist for the user at the one or more other web applications;
sending, by the logout endpoint at the portal web application, instructions to one or more logout endpoints at the one or more other web applications to trigger one or more logout processes and to destroy the one or more other user sessions associated with the user at the one or more other web applications;
logging out the user by destroying the user session at the portal web application; and
providing a notification for a result of the logout for the user at the portal web application.

2. The computer-implemented method of claim 1, wherein the received request to logout is a first request, and wherein the method further comprises:
sending a second request to an identity provider to destroy a user session created for the user at the identity provider when the user was logged on the portal web application using the identity provider for an identity authentication.

3. The computer-implemented method of claim 1, wherein the logging out of the user from the user session at the portal web application is performed before the one or more logout processes triggered at the one or more other web applications are completed.

4. The computer-implemented method of claim 1, wherein the provided notification for the result is a first notification, and wherein providing the first notification for the result of the logout of the user at the portal web application comprises:
receiving one or more notifications from one or more logout executions for the user at the one or more other user sessions, the one or more logout executions being performed at an identity provider associated with the one or more other web applications.

5. The computer-implemented method of claim 4, wherein the identity provider associated with the one or more other web applications is identical to an identity provider used for authenticating the user for the user session at the portal web application.

6. The computer-implemented method of claim 1, wherein providing the notification for the result of the logout comprises providing one or more statuses of execution of the one or more logout processes as triggered by the one or more logout endpoints at the one or more other web applications.

7. The computer-implemented method of claim 1, wherein determining whether the portal web application embeds the one or more other web applications comprises:
obtaining input from an identity provider for at least one more user session associated with the user that is existing at the identity provider for the user and is associated with at least one web application embedded in the portal web application, wherein authentication at the at least one web application embedded in the portal web application is performed at the identity provider.

8. The computer-implemented method of claim 1, wherein determining whether the portal web application embeds the one or more other web applications comprises:
obtaining a notification from an identity provider, the notification being indicative of another user session for the user at another web application embedded in the portal web application.

9. The computer-implemented method of claim 7, wherein determining whether the portal web application embeds the one or more other web applications comprises:
determining, by the logout endpoint at the portal web application, whether an additional embedded web application to the portal web application is registered with another identity provider for executing user authentication,
wherein sending, by the logout endpoint at the portal web application, instructions, comprises:
sending further instructions to another identity provider for triggering a logout process to destroy a user session associated with the user at the additional embedded web application.

10. The computer-implemented method of claim 1, comprising:
receiving a new request to log-in at the portal web application by another user;
in response to receiving the request, determining whether another user is associated with an existing user session;
in response to determining that another user is not associated with an existing user session, triggering an authentication of another user at an identity provider; and
in response to determining that another user is associated with an existing user session, providing access to another user to resources at a first other web application embedded in the portal web application upon authentication for the first other web application without performing a new authentication for another user at the portal web application.

11. A non-transitory, computer-readable medium storing one or more instructions executable by a computer system to perform one or more operations, comprising:
receiving a request to logout a user from a user session at a portal web application;
determining, at a logout endpoint at the portal web application, whether the portal web application embeds one or more other web applications, wherein one or more other user sessions exist for the user at the one or more other web applications;
sending, by the logout endpoint at the portal web application, instructions to one or more logout endpoints at the one or more other web applications to trigger one or more logout processes and to destroy the one or more other user sessions associated with the user at the one or more other web applications;
logging out the user by destroying the user session at the portal web application; and
providing a notification for a result of the logout for the user at the portal web application.

12. The non-transitory, computer-readable medium of claim 11, wherein the received request to logout is a first request, and wherein the operations further comprise:
sending a second request to an identity provider to destroy a user session created for the user at the identity provider when the user was logged on the portal web application using the identity provider for an identity authentication.

13. The non-transitory, computer-readable medium of claim 11, wherein the logging out of the user from the user session at the portal web application is performed before the one or more logout processes triggered at the one or more other web applications are completed.

14. The non-transitory, computer-readable medium of claim 11, wherein the provided notification for the result is a first notification, and wherein providing the first notification for the result of the logout of the user at the portal web application comprises:
receiving one or more notifications from one or more logout executions for the user at the one or more other user sessions, the one or more logout executions being performed at an identity provider associated with the one or more other web applications.

15. The non-transitory, computer-readable medium of claim 14, wherein the identity provider associated with the one or more other web applications is identical to an identity provider used for authenticating the user for the user session at the portal web application.

16. The non-transitory, computer-readable medium of claim 11, wherein providing the notification for the result of the logout comprises providing one or more statuses of execution of the one or more logout processes as triggered by the one or more logout endpoints at the one or more other web applications.

17. The non-transitory, computer-readable medium of claim 11, wherein determining whether the portal web application embeds the one or more other web applications comprises:
obtaining input from an identity provider for at least one more user session associated with the user that is existing at the identity provider for the user and is associated with at least one web application embedded in the portal web application, wherein authentication at the at least one web application embedded in the portal web application is performed at the identity provider.

18. The non-transitory, computer-readable medium of claim 11, wherein determining whether the portal web application embeds the one or more other web applications comprises:
obtaining a notification from an identity provider, the notification being indicative of another user session for the user at another web application embedded in the portal web application.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving a request to logout a user from a user session at a portal web application;
determining, at a logout endpoint at the portal web application, whether the portal web application embeds one or more other web applications, wherein one or more other user sessions exist for the user at the one or more other web applications;
sending, by the logout endpoint at the portal web application, instructions to one or more logout endpoints at the one or more other web applications to trigger one or more logout processes and to destroy the one or more other user sessions associated with the user at the one or more other web applications;
logging out the user by destroying the user session at the portal web application; and
providing a notification for a result of the logout for the user at the portal web application.

20. The computer-implemented system of claim 19, wherein the received request to logout is a first request, and wherein the non-transitory, machine-readable media further stores instructions, which when executed by the one or more computers perform operations comprising:
sending a second request to an identity provider to destroy a user session created for the user at the identity provider when the user was logged on the portal web application using the identity provider for an identity authentication.
